(19) United States
(12) Patent Application Publication
(10) Pub. No.: US 2025/0298124 A1
(43) Pub. Date: Sep. 25, 2025

(54) DUAL-POLARIZED GROUND PENETRATING RADAR FOR ELECTROMAGNETIC PARAMETER CHARACTERIZATION FROM SUBSURFACE RADAR RETURNS

(71) Applicant: University of Notre Dame du Lac, South Bend, IN (US)

(72) Inventors: Thomas G. Pratt, South Bend, IN (US); Robert D. Kossler, South Bend, IN (US); Luke Saladis, South Bend, IN (US)

(73) Assignee: University of Notre Dame du Lac, South Bend, IN (US)

(21) Appl. No.: 19/000,956

(22) Filed: Dec. 24, 2024

Related U.S. Application Data
(60) Provisional application No. 63/568,142, filed on Mar. 21, 2024.

(51) Int. Cl. G01S 7/41; G01S 7/02; G01S 13/88

(52) U.S. Cl. CPC G01S 7/411; G01S 7/024; G01S 13/885

(57) ABSTRACT

System, Apparatus and Method for characterizing subsurface electromagnetic properties of multiple material layers, the method includes producing at least a electromagnetic waves centered at a predetermined frequency with a specified bandwidth through a dual-polarized transmitter array to generate at least a orthogonally-polarized electromagnetic waves, transmitting the orthogonally-polarized electromagnetic waves into a ground target includes a set of multiple material layers, detecting, through a set of dual-polarized receiving antennas, reflected electromagnetic waves from subsurface layer boundaries, where the set of receiving antennas are oriented to capture both parallel and perpendicular polarizations relative to the transmitted waves, implementing, through a processing unit, at least a four-dimensional suppression of unwanted signals from the detected reflected electromagnetic waves, determining electromagnetic properties of the detected subsurface material layers through spiral estimation, calculating, for detected material layer at least, a dielectric permittivity, a conductivity, a wavelength and a skin depth based on the reflected electromagnetic waves.

### CROSS-REFERENCE TO RELATED APPLICATIONS

This utility patent application claims priority to U.S. Provisional Application No. 63/568,142, filed Mar. 21, 2024, which is incorporated herein by reference.

### BACKGROUND

Ground Penetrating Radar (GPR) technology has traditionally been used for subsurface investigation and characterization, operating by transmitting electromagnetic waves into the ground and analyzing their reflections. Conventional GPR systems typically employ single-polarization techniques, which limit their ability to fully characterize complex subsurface environments. While these systems can detect subsurface objects and layer boundaries, they often struggle to provide detailed electromagnetic property measurements of different materials, particularly in multi-layered environments. Current technologies face challenges in distinguishing between materials with similar dielectric properties but different conductivities, such as fresh water versus salt water. Additionally, existing systems generally lack the capability to simultaneously measure multiple electromagnetic parameters while maintaining high spatial resolution.

### SUMMARY

The general technology is based on a dual-polarized radar implementation. This solution leveraged polarization-dependent outputs that occurs when the transmitted radio frequency signals propagate through space and interact with various objects and surfaces in the environment and are received by a dual-polarized receive architecture.

The disclosed Radio Frequency Polarization Mode Dispersion (RF-PMD) technology represents a solution using ground penetrating radar system that enables extended subsurface characterization through dual-polarized electromagnetic wave analysis. This system uses orthogonal polarization capabilities combined with signal processing techniques, enabling an extended electromagnetic parameter estimation across multiple subsurface layers.

The system employs a dual-polarized antenna array that transmits electromagnetic waves centered at predetermined frequencies with specified bandwidths. By analyzing the full polarization returns from subsurface boundaries, the system can determine more detailed electromagnetic properties including dielectric permittivity, conductivity, wavelength, and skin depth for multiple material layers. This capability enables non-destructive subsurface analysis with enhanced detail and accuracy.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a Block diagram illustrating the hardware architecture and system components of the RF-PMD ground penetrating radar system.

FIG. 2 illustrates a schematic diagram showing the dual-polarized antenna configuration and signal transmission/reception paths of the RF-PMD system.

FIG. 3A illustrates a process for characterizing subsurface electromagnetic properties of multiple material layers in accordance with one embodiment.

FIG. 3B illustrates a continuing flow chart for process for characterizing subsurface electromagnetic properties of multiple material layers in accordance with one embodiment.

FIG. 3C illustrates an aspect of the subject matter in accordance with one embodiment.

FIG. 4 illustrates an aspect of the reflection and refraction of a traveling electromagnetic wave due to different refractive indices, n1, n2, and n3, in three parallel, homogeneous media. in accordance with one embodiment.

FIG. 5 illustrates an aspect of the electromagnetic properties of medium 2 (pure water in this example) and dielectric permittivity of medium 3 (air in this example) as a function of frequency from 865 to 965 MHz.

### DETAILED DESCRIPTION

The disclosed technology encompasses systems, methodologies, and/or computer program commodities at varying degrees of technical integration. Such a computer program commodity may comprise a machine-readable storage medium (or multiple mediums) bearing machine-executable instructions to prompt a processor to execute components of the specified technology.

This machine-readable medium is a physical entity capable of maintaining and storing instructions to be utilized by an instruction execution apparatus. The medium could be, for example, but not restricted to, electronic, magnetic, optical, electromagnetic, semiconductor storage devices, or a fusion of these. A non-limiting list of specific instances of the machine-readable medium includes portable computer diskettes, hard drives, RAM, ROM, EPROM or Flash memory, SRAM, CD-ROMs, DVDs, memory sticks, floppy disks, and mechanical devices like punch-cards or tangible structures with instructions. It should be clarified that the aforementioned medium does not consider transitory signals in isolation, like free-propagating electromagnetic waves or electrical signals over wires.

The machine-executable instructions detailed can be transferred to diverse computational devices from the machine-readable medium or an external computer or storage via networks like the Internet, LANs, WANs, or wireless networks. Such networks may integrate copper or optical fibers, wireless transmission mechanisms, routers, firewalls, switches, gateway computers, and edge servers. Within each computational device, a network interface or adapter fetches the instructions from the network, forwarding them for retention in the device's machine-readable medium.

Instructions facilitating operations of this technology might be encoded as assembler instructions, ISA instructions, machine codes, microcode, firmware instructions, circuit configuration data, or code (both source and object) in diverse programming languages. Examples include but aren't restricted to object-oriented languages like Python, Java, C++, and procedural ones like the “C” language. These instructions might operate wholly on a local computer, partly on local and remote computers, or entirely remotely. Remote computers can be linked via networks, inclusive of the Internet via ISPs. In certain cases, hardware such as FPGAs or PLAs could employ the instructions, utilizing their state data to modify the hardware to actualize facets of the technology.

The technology's facets are expounded with reference to flowcharts and block diagrams of methods, systems, and computer program products per its embodiments. Each block in these can be realized via machine-executable instructions. These instructions could be presented to a processor in general-purpose computers, specialized computers, or other programmable data apparatuses, crafting a machine that institutes the functions denoted in the diagrams. Furthermore, these instructions could be conserved within a machine-readable medium directing device to operate in a specific fashion. The instructions could also be loaded onto a computer or device to prompt a sequence of tasks producing a computer-driven process.

The depicted flowcharts and diagrams exhibit potential system, method, and product architectures and functionalities per the technology's embodiments. It's essential to note that these blocks, or their combinations, can be realized by hardware systems specifically designed for those tasks or combinations of hardware and machine instructions.

While multiple embodiments have been detailed, skilled individuals will recognize that modifications can be made without diverging from the broader aspects of the technology. The term “user” here pertains to any individual or entity interacting with the described contract analysis and generation system. “User device” signifies any computational apparatus, from PCs to mobile devices like smartphones, laptops, wearables, and more, employed to access the system. The term “entity” encompasses organizations or user groups engaging with the system, such as businesses or companies either operating or accessing the system.

The Ground Penetrating Radar (GPR) system described herein represents a solution for subsurface characterization capabilities. This solution differentiates itself from conventional GPR technology through its implementation of dual-polarized transmission capabilities and electromagnetic parameter estimation techniques. While traditional GPR systems primarily focus on basic detection, this solution system provides comprehensive electromagnetic characterization through sophisticated analysis of full-polarization returns from subsurface boundaries, enabling lexicographic imaging techniques and delivering estimates of electromagnetic parameters and layer thickness measurements. The system enables non-destructive subsurface analysis with expanded capabilities in determining dielectric permittivity, conductivity, wavelength, and skin depth of multiple layers. These capabilities make it particularly valuable for Earth-based, lunar, and outer-space applications, including water detection, mineral prospecting, and infrastructure planning.

The general technology is based on a dual-polarized radar architecture. This solution optimizes and interprets the outputs that occurs when transmitted radio frequency signals propagate through space and interact with various objects and surfaces in the environment. This interaction causes changes in the polarization states of the RF waves, creating a complex pattern of signal variances that can be analyzed to extract valuable information about both the signal characteristics and the materials and compositions that make up the propagation environment.

RF signals are typically transmitted with specific polarization orientations—either linear (vertical or horizontal), circular, or elliptical. When these signals encounter objects or surfaces, they undergo various transformations in their polarization states. These transformations occur due to multiple physical mechanisms, including reflection, refraction, diffraction, and scattering depending on the materials encountered.

During signal propagation, the original RF wave may split into multiple components with different polarization states. These components travel through slightly different paths and experience varying delays and attenuation levels. When these components recombine at the receiver, they create a composite signal that contains rich information about the entire propagation path and the objects encountered along the way.

The polarization changes induced by the environment create unique signatures that can be used to identify and classify different types of objects, materials, and surfaces.

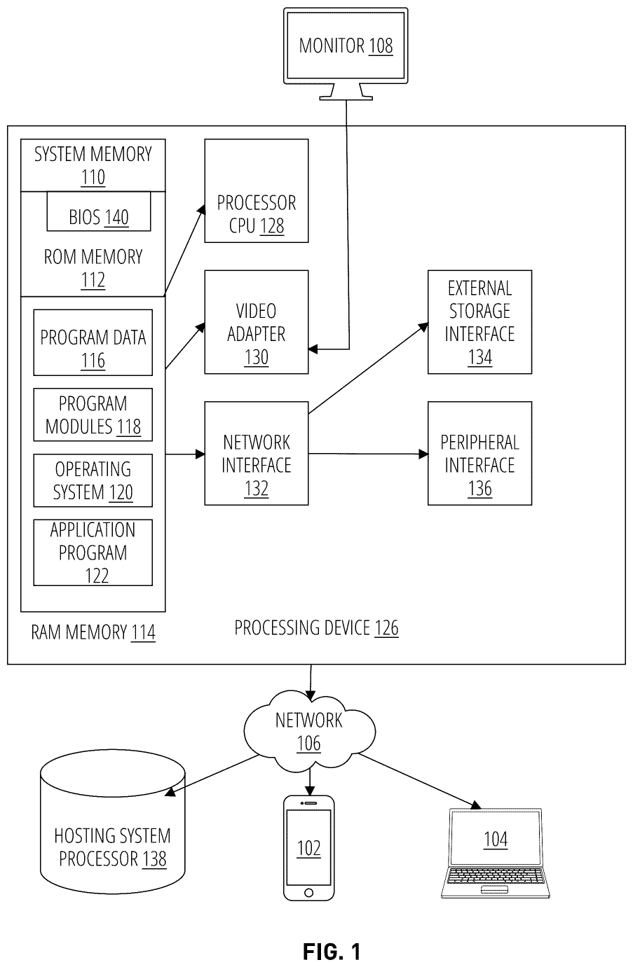

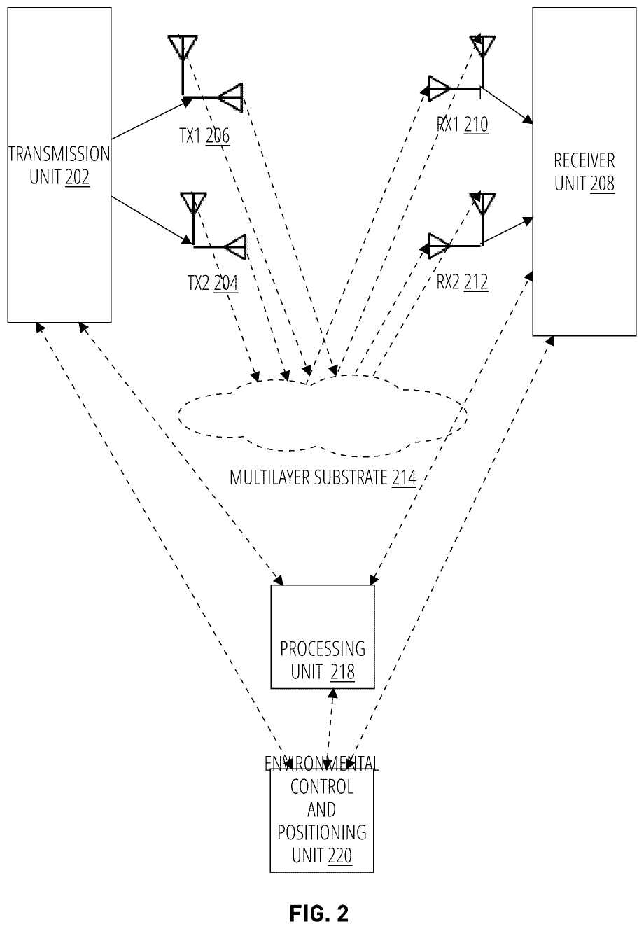

To this end, FIG. 2 illustrates a Processing Device 126, illustrated in the exemplary form of a Mobile Processor 102′, illustrated in the exemplary form of a computer system, and a Laptop Processor 104 illustrated in schematic form, such as for example, a home computer, each of which may be provided with executable instructions to, for example, provide a means for a customer, e.g., an end user, representative, consumer, etc., to interact with the Processing Devices 126 and/or to access a Hosting System Processor 138. Generally, the computer executable instructions reside in program modules which may include routines, programs, objects, components, data structures, etc. that perform particular tasks or implement particular abstract data types. Accordingly, those of ordinary skill in the art will appreciate that the processing devices illustrated in FIG. 1 may be embodied in any device having the ability to execute instructions such as, by way of example, an appliance, a personal computer, mainframe computer, a cloud instance, a mobile device, tablet, or the like. Furthermore, while described and illustrated in the context of a Processing Device 126 those of ordinary skill in the art will also appreciate that the various tasks described hereinafter may be practiced in a distributed environment having multiple processing devices linked via a local and/or wide-area network whereby the executable instructions may be associated with and/or executed by one or more of multiple processing devices. Still further, while described and illustrated in the context of a networked system, it will be understood that various portions of the present disclosure may be integrated into a single stand-alone environment.

For performing the various tasks in accordance with the executable instructions, the example Processing Device 126 includes a Processing Device 126 and a System Memory 110 which may be linked via a bus within the Processing Device 126. Without limitation, the bus may be a memory bus, a peripheral bus, and/or a local bus using any of a variety of bus architectures. As needed for any particular purpose, the System Memory 110 may include read only memory ROM Memory 112 and/or random-access memory RAM Memory 1140. Additional memory devices may also be made accessible to the Processing Device 126 by means of, for example, an External Storage Interface 134 accessing a hard disk drive or another type of memory storage. As will be understood, these devices, which would be linked to the system bus, respectively allow for reading from and writing to a hard disk, reading from or writing to a removable magnetic disk, and for reading from or writing to a removable optical disk, such as a CD/DVD ROM or other optical media. The drive interfaces and their associated computer-readable media allow for the nonvolatile storage of computer readable instructions, data structures, program modules and other data for the Processing Devices 126. Those of ordinary skill in the art will further appreciate that other types of non-transitory computer readable media that can store data and/or instructions may be used for this same purpose. Examples of such media devices include, but are not limited to, USB flash drives (thumb drives), memory cards (SD cards, microSD), external hard drives (HDDs), external solid-state drives (SSDs), portable hard drives, network-attached storage (NAS), cloud storage drives (like Google Drive, OneDrive, Dropbox), and older options like floppy disks and optical discs (CDs, DVDs).

A number of program modules may be stored in one or more of the memory/media devices. For example, a basic input/output system BIOS 140, containing the basic routines that help to transfer information between elements within the Processing Device 126, such as during start-up, may be stored in ROM Memory 112. Similarly, the RAM Memory 114, hard drive, and/or peripheral memory devices may be used to store computer executable instructions comprising an operating system, one or more applications programs (such as a Web browser), other program modules, and/or program data. Still further, computer-executable instructions may be downloaded to one or more of the computing devices as needed, for example via a network 106.

To allow a user to enter commands and information into the Processing Device 126 input devices such as a keyboard and/or a pointing device are provided via the Peripheral interface 136. While not illustrated, other input devices may include a microphone, a joystick, a game pad, a scanner, a camera, touchpad, touch screen, and arrays of sensors, (e.g. motion sensor). These and other input devices would typically be connected to the Processing Device 126 by means of a Peripheral interface 136 which, in turn, would be coupled to the bus. Input devices may be connected to the Processor CPUs 128 using interfaces such as, for example, a parallel port, game port, firewire, or a universal serial bus (USB). To view information from the Processing Device 126, a Monitors 108 or other type of display device may also be connected to the bus via an interface, such as a Video Adapter 130. In addition to the Monitor 108, the Processing Device 126 may also include other peripheral output devices, not shown, such as, for example, speakers, cameras, printers, or other suitable device attached via Peripheral interfaces 136.

As noted, the Processing Device 126 may also utilize logical connections to one or more remote processing devices, such as the Hosting System Processor 138 having associated data repository. In this example, the Hosting System Processor 138 may act as a processor as described herein. In this regard, while the Hosting System Processor 138 has been illustrated in the exemplary form of a computer, it will be appreciated that the Hosting System Processor 138 may, like Processing Device 126 be any type of device having processing capabilities. Again, it will be appreciated that the Hosting System Processor 138 need not be implemented as a single device but may be implemented in a manner such that the tasks performed by the Hosting System Processor 138 are distributed amongst a plurality of processing devices/databases located at different geographical locations and linked through a network 106. Additionally, the Hosting System Processor 138 may have logical connections to other third party systems via a Network 106, such as, for example, the Internet, LAN, MAN, WAN, cellular network, cloud network, enterprise network, virtual private network, wired and/or wireless network, or other suitable network, and via such connections, will be associated with data repositories that are associated with such other third party systems. Such third-party systems may include, without limitation, systems of banking, credit, or other financial institutions, systems of third party providers of goods and/or services (e.g., inventory), systems of shipping/delivery companies, etc.

For performing tasks as needed, the Hosting System Processor 138 may include many or all of the elements described above relative to the Processing Device 126. Communications between the Processing Device 126 and the Hosting System Processor 138 may be exchanged via a further processing device, such as a network router (not shown), that is responsible for network routing. Communications with the network router may be performed via a Network Interface 132. Thus, within such a networked environment, e.g., the Internet, World Wide Web, LAN, cloud, or other like type of wired or wireless network, it will be appreciated that program modules depicted relative to the Processing Device 126, or portions thereof, may be stored in the non-transitory memory storage device(s) of the Hosting System Processor 138.

The GPR hardware architecture consists of four primary subsystems: In FIG. 2, the Transmission Unit 202 architecture incorporates hardware components used in a dual-polarized transmission. A dual-polarized antenna array TX1 206 TX2 204 that allows orthogonal polarization capabilities, wide bandwidth operation, and isolation between polarization channels, while maintaining temperature-stability of the system. The RF frontend implements a plurality of dual-channel transmission paths, utilizing linearity amplifiers and phase control. These components work in concert with a timing and synchronization system that provides clock distribution and phase synchronization between channels. (achieved, for example, through a shared local oscillator) A variant of the solution implements a Software Defined Radio (SDR) transceiver to allow the variant to provide programmable transmit and receive configurations and operation. The SDR is a radio device where the key functions like modulation, filtering, and demodulation are primarily controlled by software, allowing for flexible and programmable transmit and receive configurations, essentially enabling the radio to adapt to different communication protocols and waveforms simply by changing the software settings, rather than requiring significant hardware modifications; this makes it highly versatile and adaptable to various applications.

The reception system matches the transmission components, using a matched set of dual-polarized receiving antennas with matched polarization characteristics and cross-polar isolation across a dynamic range. Signal conditioning is done with low-noise amplifiers, anti-aliasing filters, and variable gain control systems. The data acquisition subsystem employs high-speed analog-to-digital conversion with simultaneous sampling capabilities and substantial data buffer capacity to handle the complex return signals.

The hardware architecture consists of four primary subsystems:

Transmission Unit 202 generates and transmits the radar signals. By example, a signal generator produces waveforms centered at 915 MHz with 100 MHz bandwidth. These signals pass through a power amplification stage before reaching the dual-polarized antenna array. A transmission control unit manages signal generation timing and maintains phase coherence across the system. For the purposes of this disclosure the functional ranges of carrier frequencies in the following channels are disclosed as follows. For the radar system's transmission subsystem, each frequency channel operates with specific waveform characteristics optimized for the intended application. At the lowest frequency channel of 3494.4 MHz, the system generates waveforms with a bandwidth of 499.2 MHz, providing a balance between range resolution and penetration depth suitable for medium-range detection scenarios. Moving to the middle channel centered at 3993.6 MHz, the system maintains the same 499.2 MHz bandwidth while operating at a higher carrier frequency, which can offer improved angular resolution compared to the lower channel. The highest frequency channel, operating at 4492.8 MHz, also utilizes a 499.2 MHz bandwidth, potentially providing the finest spatial resolution among the three channels while potentially being more susceptible to atmospheric attenuation. The consistent bandwidth across all three channels suggests a design emphasis on maintaining uniform range resolution capabilities, with the sequential spacing of carrier frequencies potentially allowing for frequency diversity techniques to enhance detection reliability.

Receiving Receiver Unit 208 begins with a dual-polarized receiving antenna array RX1 210 and RX2 212 optimized for the operating frequency band. Received signals pass through low-noise amplifiers to improve signal-to-noise ratio before down-conversion. High-speed analog-to-digital converters digitize the received signals for processing. The system maintains precise timing synchronization between transmission and reception to enable accurate two-way travel time measurements.

Processing Unit 218 comprising an FPGA-based or other processor based processing unit does real-time signal processing operations. This subsystem implements the range filtering and/or 4D suppression algorithm and manages the initial stages of electromagnetic parameter estimation. The processing chain includes hardware for spiral estimation calculations and polarimetric analysis. An embedded specialized computer system handles higher-level processing tasks and system control.

Environmental Control and Positioning Units 220 Subsystem This subsystem includes temperature sensors for maintaining calibration accuracy, as calculations assume 22° C. operating temperature. A GPS/IMU combination provides positioning data for spatial reference. The entire system is housed in ruggedized enclosures suitable for field deployment in various environmental conditions.

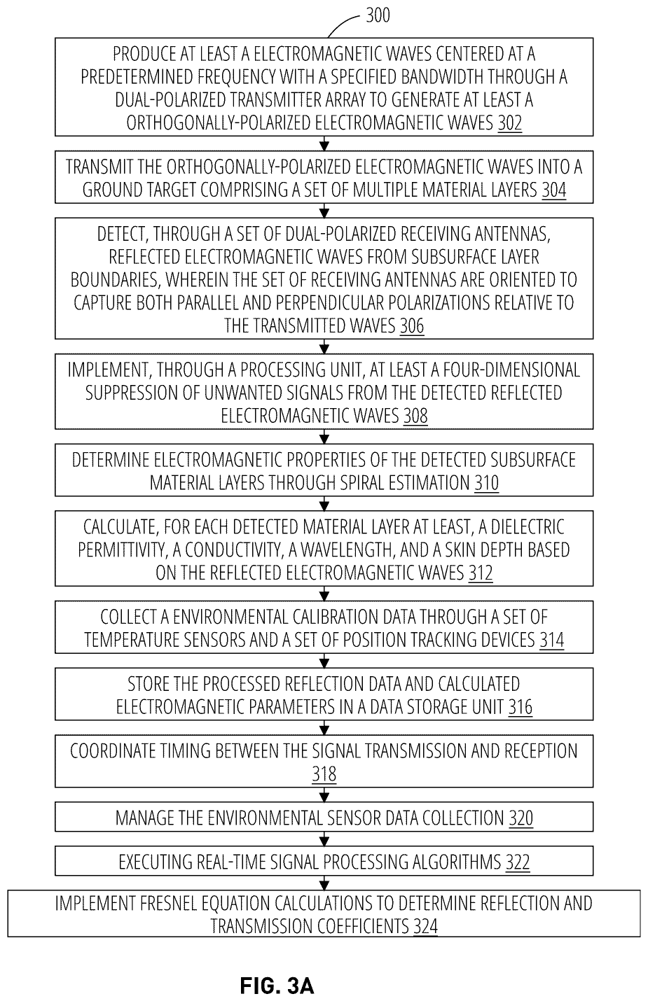

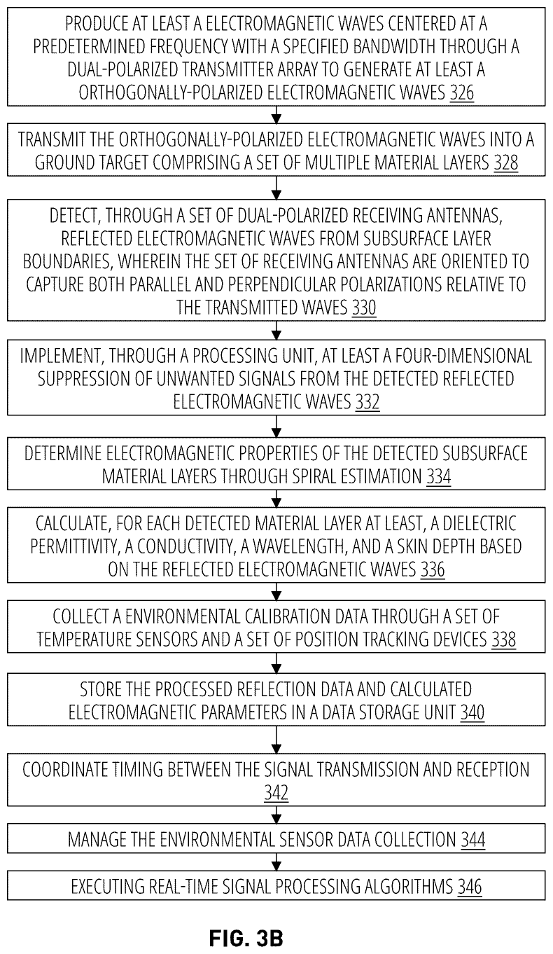

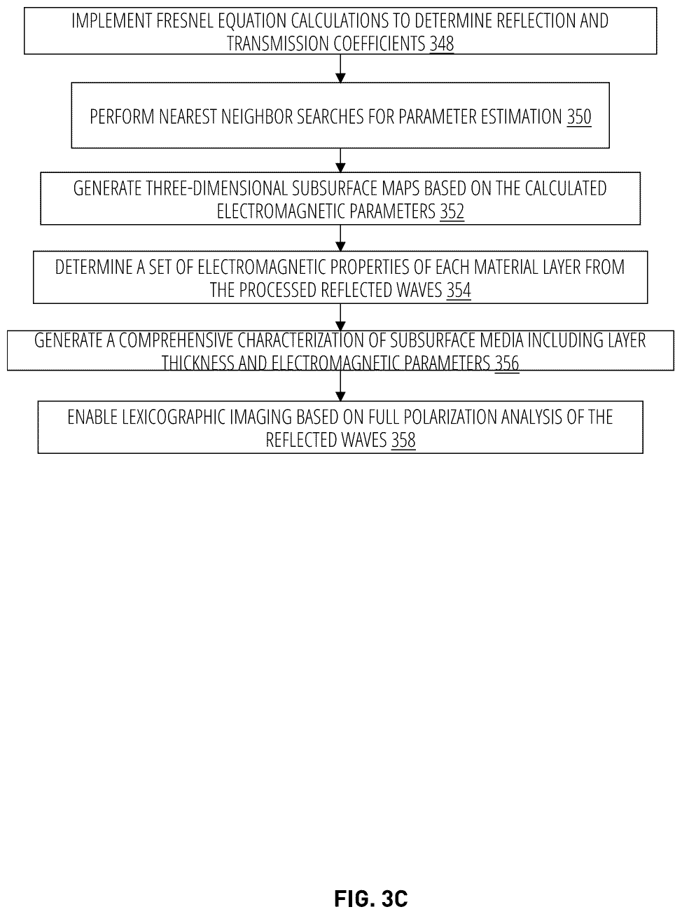

FIG. 3A, FIG. 3B, and FIG. 3C outline the Process 300 by which the solution operates. In Step 302, Process 300 produces at least a electromagnetic waves centered at a predetermined frequency with a specified bandwidth through a dual-polarized transmitter array to generate at least a orthogonally-polarized electromagnetic waves. In Step 304, Process 300 transmits the orthogonally polarized electromagnetic waves into a ground target comprising a set of multiple material layers. In Step 306, Process 300 detects, through a set of dual-polarized receiving antennas, reflected electromagnetic waves from subsurface layer boundaries, wherein the set of receiving antennas are oriented to capture both parallel and perpendicular polarizations relative to the transmitted waves. In Step 308, Process 300 implements, through a processing unit, at least a suppression of unwanted signals from the detected reflected electromagnetic waves by using range filtering and/or 4D polarization suppression. In Step 310, Process 300 determines electromagnetic properties of the detected subsurface material layers through spiral estimation. In Step 312, Process 300 calculates, for each detected material layer at least, a dielectric permittivity, a conductivity, a wavelength, and a skin depth based on the reflected electromagnetic waves. In block 314, Process 300 collects a environmental calibration data through a set of temperature sensors and a set of position tracking devices. In Step 316, Process 300 stores the processed reflection data and calculated electromagnetic parameters in a data storage unit. In Step 318, Process 300 coordinates timing between the signal transmission and reception. In Step 320, Process 300 manages the environmental sensor data collection. In Step 322, Process 300 executing real-time signal processing algorithms. In Step 324, Process 300 implements Fresnel equation calculations to determine reflection and transmission coefficients.

In Step 326, produces at least a electromagnetic waves centered at a predetermined frequency with a specified bandwidth through a dual-polarized transmitter array to generate at least a orthogonally-polarized electromagnetic waves. In Step 328, transmits the orthogonally polarized electromagnetic waves into a ground target comprising a set of multiple material layers. In Step 330, detects, through a set of dual-polarized receiving antennas, reflected electromagnetic waves from subsurface layer boundaries, wherein the set of receiving antennas are oriented to capture both parallel and perpendicular polarizations relative to the transmitted waves. In Step 332, implements, through a processing unit, suppression using either range filtering and/or a four-dimensional suppression of unwanted signals from the detected reflected electromagnetic waves. In Step 334, determines electromagnetic properties of the detected subsurface material layers through spiral estimation. In Step 336, calculates, for each detected material layer at least, a dielectric permittivity, a conductivity, a wavelength, and a skin depth based on the reflected electromagnetic waves. In Step 338, collects a environmental calibration data through a set of temperature sensors and a set of position tracking devices. In Step 340, stores the processed reflection data and calculated electromagnetic parameters in a data storage unit. In Step 342, coordinates timing between the signal transmission and reception. In Step 344, manages the environmental sensor data collection. In Step 346, executing real-time signal processing algorithms.

In Step 348, implements Fresnel equation calculations to determine reflection and transmission coefficients. In Step 350, performs nearest neighbor searches for parameter estimation. In Step 352, generates three-dimensional subsurface maps based on the calculated electromagnetic parameters. In Step 354, determines a set of electromagnetic properties of each material layer from the processed reflected waves. In Step 356, generates a comprehensive characterization of subsurface media including layer thickness and electromagnetic parameters. In Step 358, enables lexicographic imaging based on full polarization analysis of the reflected waves.

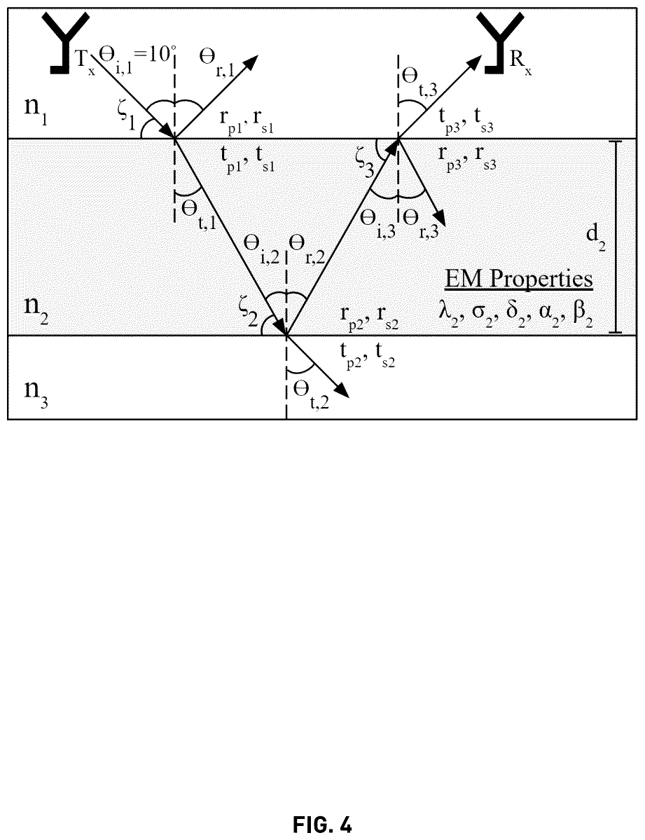

FIG. 4 is a model of Measured Complex Signal Power for an incident plane wave traveling in the +\hat{ }z direction, the electric field can be described as

$${\hat{E}}_{x} ( z ) = {\hat{E}}_{m}^{+} {e}^{- α z} {e}^{- j β z} + {\hat{E}}_{m}^{-} {e}^{α z} {e}^{j β z}$$

where \hat{ }E+m and \hat{ }E−m are the magnitudes of the forward and backward propagating electric waves, α is the attenuation constant, and β is the propagation constant. In a dual-polarized radar system, two orthogonally polarized electromagnetic plane waves are transmitted and received, specifically in the parallel (p) and perpendicular (s) polarizations relative to the plane of incidence. As the incident plane waves encounter impedance discontinuities between media, the waves will bend and separate into reflected and transmitted waves as shown in FIG. 2. The reflected waves are measured as complex signal powers in the general form of

$${P}_{p} = {P}_{p} {e}^{j Φ} ; {P}_{s} = {P}_{s} {e}^{j Φ}$$

where Pp and Ps are the measured complex signal powers in the p- and s-polarizations, Pp and Ps are the magnitudes which depend on the reflection and transmission coefficients at the boundaries between media and two-way path loss, and Φ is the measured, ambiguous phase shift within the range of [0,2π]. If the thickness of a medium is longer than the transmitted wavelength, the total, unambiguous two-way phase shift will not be collected in Pp or Ps. The reflection and transmission coefficients are denoted as rp, rs, tp, and ts, and are quantified by the Fresnel Equations.

Consider the three-layer scenario where the radar transmits in free space, i.e., ϵr1=1. In natural media at an ambient temperature of 22° C., the lowest relative dielectric permittivity is ϵr=1 for free space and the largest is ϵr=80 for pure water, defining a finite range called ϵset. If we replace n2 in (3) and (4) with ϵset, Γp and Γs become functions of all possible ϵr values in natural media. At the first boundary between n1 and n2, the magnitudes of the measured complex signal powers only depend on the reflection coefficients rp1 and rs1. We can use the Nearest Neighbor Search (NNS) method, which identifies the data point in a function closest to the query point of interest, to determine ϵr2. The NNS method is applied in this work by calculating the minimum difference between the ratio of rp1/rs1 and the ratio of Γp/Γs. Since the ratio of Γ is also a function ϵset, the index at which the minimum is located determines the value of ϵr2. To determine ϵr3, the magnitudes of the power measured from boundary 2 between n2 and n3 can be rearranged to solve for the ratio of reflection coefficients at this boundary using:

$${r}_{2 , ratio} = \frac{{r}_{p 2}}{{r}_{s 2}} = \frac{{P}_{p 2} {t}_{s 1} {t}_{s 3}}{{P}_{s 2} {t}_{p 1} {t}_{p 3}} = \frac{{P}_{p 2}}{{P}_{s 2}} \frac{1}{{t}_{1 , ratio}^{2}} .$$

The reflection coefficients at boundary 1 and tp1 and ts1 can be calculated using Snell's Law and Fresnel's Equations. Due to parallel media, the ratio of reflection or transmission coefficients across the same boundary are equal such that tp1/ts1=tp3/ts3=t1,ratio and simplifies to the rightmost side of the equation. Therefore, r2,ratio across boundary 2 can be calculated and the NNS method can be used to determine ϵr3. For an arbitrary number of homogeneous, parallel media of N layers, the ratio of reflection coefficients across the N−1 boundary is given by

$${r}_{𝒩 - 1 , ratio} = \frac{{r}_{p ( 𝒩 - 1 )}}{{r}_{s ( 𝒩 - 1 )}} = \frac{{P}_{p ( 𝒩 - 1 )}}{{P}_{s ( 𝒩 - 1 )}} {\prod }_{i = 1}^{𝒩 - 2} \frac{1}{{t}_{i , ratio}^{2}} ,$$

and the NNS method can be employed to determine ϵr of any medium in a multilayered system. The wavelength of the electromagnetic wave traveling through medium 2 is defined by

$${λ}_{2} = \frac{c}{f \sqrt{{ϵ}_{r 2}}}$$

where c is the speed of light and f is the operating frequency.

In a coherent radar system the two-way travel time between transmitted and received responses, r2, is measurable such that the depth, d2, can be estimated by

$${d}_{2} = \frac{{τ}_{2} c}{2 \sqrt{{ϵ}_{r 2}}} .$$

The two-way path loss, k2, is determined by the definition of the measured complex signal power magnitude.

$$k 2 = Pp 2 tp 1 rp 2 tp 3. \qquad ( 9 )$$

The total accumulated phase shift, ϕ2, depends on the depth of the medium and the wavelength of the electromagnetic wave given by

$$ϕ 2 = d 4 πf √ ∈ r 2 c . \qquad ( 10 )$$

Note that in both p- and s-polarized measurements, k2 and ϕ2 are unchanged across polarization because the transmitted signals travel the same distance and accumulate the same phase. By defining γ2 as the ratio between ϕ2 in radians and logarithmic two-way path loss, a direct relationship between the conductivity, σ2, and ϵ2 is established as

$${σ}_{2} = ( ω \sqrt{\frac{{( {γ}_{2}^{2} + 1 )}^{2}}{{( {γ}_{2}^{2} - 1 )}^{2}} - 1} ) {ϵ}_{2} ,$$

where ω is the angular frequency defined by ω=2πf. To characterize the skin depth of medium 2, δ2, first α2 and β2 are determined

$$\begin{matrix}{α}_{2} \\ {β}_{2}\end{matrix} = \frac{ω \sqrt{{ϵ}_{2} {μ}_{2}}}{\sqrt{2}} {( \sqrt{1 + {( \frac{{σ}_{2}}{ω {ϵ}_{2}} )}^{2}} ∓ 1 )}^{1 / 2}$$

$${δ}_{2} = \frac{1}{{α}_{2}} ,$$

The depth and the following electromagnetic properties are characterizable for medium 2: ϵr2, λ2, σ2, δ2, α2, and β2. Layer 3 can only be characterized in terms of ϵr3 and λ3 due to the lack of a bottom boundary below the deepest layer. Additionally, as shown by the definitions of α2 and β2,
it is apparent that the traveling electromagnetic wave is directly dependent on both ϵr and σ. Therefore, it is important to quantify both parameters to completely and accurately determine subsurface media.

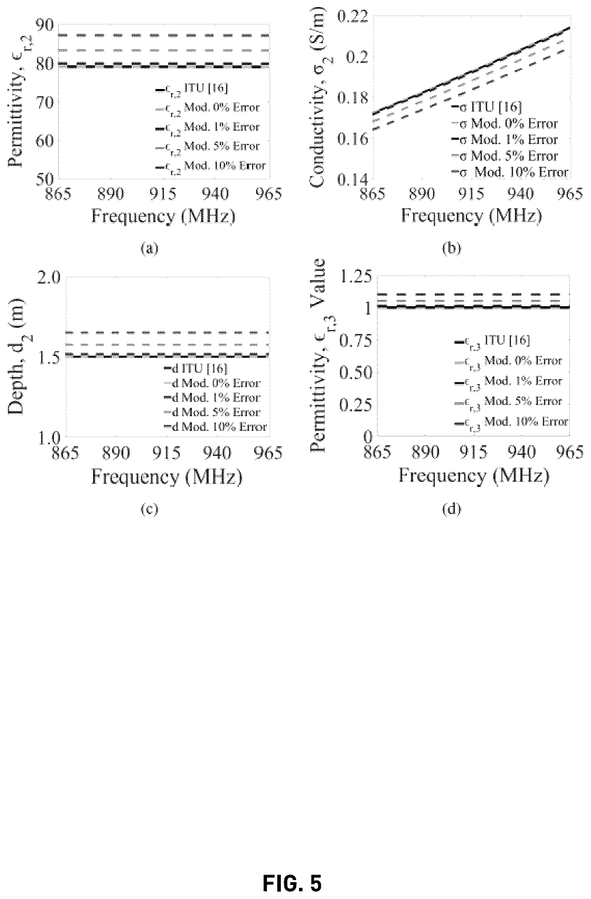

FIG. 5 shows the reflection and refraction of a traveling electromagnetic wave due to different refractive indices, n1, n2, and n3, in three parallel, homogeneous media. The electromagnetic properties of medium 2 and ϵr3 for the three layer simulation are shown in FIG. 5 from 865 to 965 MHz. With a modeled second-layer error of 10% in ϵr2, the largest subsequent layer error was 10.00% for d2 and ϵr3. For σ2, the largest error encountered was 5.50% when the 10% modeled error is present. When the modeled error for ϵr3 is 0%, numerical errors can nevertheless be present in the electromagnetic parameter estimates. In our simulation, σ2 demonstrates a maximum error of 1.82%. The cause of the error is due to quantization, and the resulting errors can be estimated by carrying the modeled error in ϵr2 through the numerical analysis As for estimation errors in σ2, the errors arises from differences in methods to estimate conductivity: in, conductivity is estimated directly by empirical experiments, however, the method described in this paper uses a modeling approach based on ϵr, k, and ϕ. Overall, the results show that calculating the permittivity of subsequent layers is within the accuracy of other current techniques. Moreover, this method also demonstrates that multiple electromagnetic properties can be estimated, which

| Layer #, | EM | EM Property due to ϵᵣ₂ Modeled % Error | | | | |
|---|---|---|---|---|---|---|
| Material | Property | [16] | 0% | 1% | 5% | 10% |
| 2, | ϵᵣ | 28.98 | 28.98 | 29.27 | 30.43 | 31.86 |
| Vegetation | λ (m) | 0.0609 | 0.0609 | 0.0606 | 0.0594 | 0.0581 |
| | σ (S/m) | 0.5309 | 0.5401 | 0.5366 | 0.5229 | 0.5072 |
| 3, | ϵᵣ | 6.919 | 6.919 | 6.988 | 7.265 | 7.611 |
| Dry Soil | λ (m) | 0.1246 | 0.1246 | 0.1240 | 0.1216 | 0.1188 |
| | σ (S/m) | 0.0710 | 0.0715 | 0.0715 | 0.0716 | 0.0717 |
| 4, | ϵᵣ | 53.99 | 53.99 | 54.22 | 55.05 | 55.95 |
| Wet Soil | λ (m) | 0.0446 | 0.0446 | 0.0445 | 0.0442 | 0.0438 |

might facilitate differentiating materials like pure water and seawater that have similar ϵr at this frequency range but very different σ. In the four-layer simulation, the electromagnetic properties of media 2 and 3 are summarized in Table 1 at a single frequency of 915 MHz. Similar to the three-layer model, these results demonstrate the efficacy of estimating electromagnetic parameters in multilayered media. This simulation also shows that an initial error in ϵr2 does not significantly perturb parameter estimation in subsequent layers, i.e., electromagnetic properties can be estimated within the 10% error when an initial layer has 10% error as well. For a modeled error of 0%, the largest error out of all measured properties was in δ2 at 1.83%, due to this parameter's dependence on σ. In FIG. 5 electromagnetic properties of medium 2 (pure water) and dielectric permittivity of medium 3 (air) as a function of frequency from 865 to 965 MHz. Each property is estimated due to modeled errors in ϵr2 of 0%, 1%, 5%, and 10%.

### ADDITIONAL CONSIDERATIONS

While the preceding description outlines various solution variants in detail, it's important to recognize that the legal scope of the invention is ultimately defined by the claims listed at the end of this patent. The detailed description serves as an illustrative example, and it is not exhaustive of all potential solution variants. Due to the impracticality of describing every conceivable solution variant, alternate configurations may exist—whether using current technologies or those developed after this patent's filing—that still fall within the scope of the claims.

Throughout this specification, references to singular instances may also include plural instances, and vice versa. Likewise, while operations of methods are described separately, they can be performed concurrently or in a different sequence than presented. Components or functionalities described as separate in example configurations may be combined, while those presented as a single entity may be divided into multiple components. These and other modifications or improvements remain within the bounds of the described invention.

In certain solution variants, logic, routines, subroutines, applications, or instructions may be executed via software (e.g., code on a non-transitory, machine-readable medium) or hardware (e.g., special-purpose processors). In a hardware context, these routines can be physical, tangible units configured in specific ways, such as through a field-programmable gate array (FPGA) or an application-specific integrated circuit (ASIC). Alternatively, they may leverage general-purpose processors configured temporarily via software to execute specific operations. Decisions on whether to implement routines in dedicated hardware, software, or hybrid solutions may depend on cost, complexity, or other constraints.

For purposes of clarity, “hardware module” should be understood to mean a tangible entity that can either be physically constructed or configured (permanently or temporarily) to operate in a specific manner. If temporarily configured via software, a general-purpose processor may act as various hardware modules at different times. This flexibility enables the same processor to perform multiple functions dynamically, depending on the system's current needs.

Inter-module communication between hardware modules may occur through signal transmission over circuits or buses. When modules are instantiated at separate times, data can be stored and retrieved from shared memory structures, enabling asynchronous operation. For instance, a hardware module may execute an operation and store its results in memory, allowing another module to access and process the stored information later.

The operations of methods described in various solution variants may be partially or fully implemented by one or more processors. These processors may be physically located within a single machine or distributed across multiple systems, enabling distributed processing. In some cases, these systems may be in a centralized location, like a data center, while in other cases, they could be spread across multiple geographic locations. When processors are distributed, they may communicate and coordinate their tasks via networked infrastructure, forming a cohesive processing system.

Terminology used herein, such as “processing,” “computing,” or “calculating,” refers to the manipulation of data in physical forms, such as electrical, magnetic, or optical quantities. When the specification refers to “one solution variant” or “a solution variant,” it indicates that the described feature may be applicable to at least one possible solution variant. This should not imply that all instances of the phrase refer to the same solution variant.

Additionally, terms like “comprises,” “including,” and their variants are intended to imply non-exclusive inclusion. For instance, a method that “comprises” certain elements is not limited to those elements alone and may include other components not explicitly listed. Similarly, “or” should be interpreted as inclusive unless otherwise specified, meaning A or B could be true individually or simultaneously.

The descriptions provided are intended as illustrative, non-exhaustive examples. They do not define every possible solution variant, as doing so would be impractical, if not impossible. Moreover, technological advancements and alternate configurations may arise that still fall within the invention's defined scope.

What is claimed is:

1. A system for characterizing subsurface electromagnetic properties of multiple material layers comprising:
a signal generation unit configured to produce electromagnetic waves centered at a predetermined frequency with a specified bandwidth, the signal generation unit further comprising a dual-polarized transmitter array for generating orthogonally polarized electromagnetic waves;
a reception unit comprising a set of dual-polarized receiving antennas configured to detect reflected electromagnetic waves from subsurface layer boundaries, wherein the set of receiving antennas are oriented to capture both parallel and perpendicular polarizations relative to the transmitted waves;
a processing unit communicatively coupled to the reception unit, the processing unit further comprising: a range filtering module configured to implement at least a four-dimensional suppression of unwanted signals; a parameter estimation module configured to implement a spiral estimation for determining electromagnetic properties of a detected subsurface material layers; a layer characterization module configured to calculate the dielectric permittivity, conductivity, wavelength, and skin depth for the each detected material layer based on the reflected electromagnetic waves;
an environmental monitoring unit comprising a set of temperature sensors and a set pf position tracking devices configured to provide calibration data for the parameter estimation calculations;
a data storage unit configured to store the processed reflection data and calculated electromagnetic parameters; and
a control unit configured to: coordinate timing between signal transmission and reception; manage environmental sensor data collection; execute real-time signal processing algorithms; implement a Fresnel equation calculations for determining reflection and transmission coefficients; perform nearest neighbor searches for parameter estimation; generate three-dimensional subsurface maps based on the calculated electromagnetic parameters;
wherein the system is configured to: transmit electromagnetic waves into a ground target comprising a set of multiple material layers; receive reflected waves from boundaries between the material layers; process the reflected waves to determine a set of electromagnetic properties of the each layer; generate a comprehensive characterization of subsurface media including layer thickness and electromagnetic parameters; and enable lexicographic imaging based on full polarization analysis of the reflected waves.

2. The system of claim 1, wherein the signal generation unit further comprises a signal generator configured to produce waveforms at a channel defined frequency and a corresponding bandwidth; a power amplification stage; and a transmission control unit configured to manage signal generation timing and maintain phase coherence across the system.

3. The system of claim 1, wherein the reception unit further comprises at least a low-noise amplifier configured to improve signal-to-noise ratio before down-conversion; at least a high-speed analog-to-digital converters configured to digitize the received signals; and a timing synchronization system configured to maintain precise timing between transmission and reception for a set of two-way travel time measurements.

4. The system of claim 1, wherein the processing unit further comprises an FPGA-based processing unit configured to: implement range filtering with a 4D suppression algorithm; manage at least a initial stages of electromagnetic parameter estimation; execute a spiral estimation calculations; and perform a polarimetric analysis.

5. The system of claim 1, wherein the environmental monitoring unit further comprises at least a temperature sensor configured to maintain calibration accuracy at 22° C. operating temperature; a GPS/IMU combination configured to provide positioning data for spatial reference.

6. The system of claim 1, wherein the control unit is further configured to calculate a two-way path loss according to k2=Pp2/(tp1rp2tp3); determine a total accumulated phase shift according to ϕ2=(4πfd√ϵr2)/c; establish a direct relationship between conductivity and permittivity through the ratio of phase shift to logarithmic two-way path loss; and characterize a skin depth of each medium through determination of α2 and β2 parameters.

7. A method for characterizing subsurface electromagnetic properties of multiple material layers, the method comprising:
producing at least a electromagnetic waves centered at a predetermined frequency with a specified bandwidth through a dual-polarized transmitter array to generate at least a orthogonally-polarized electromagnetic waves;
transmitting the orthogonally polarized electromagnetic waves into a ground target comprising a set of multiple material layers;
detecting, through a set of dual-polarized receiving antennas, reflected electromagnetic waves from subsurface layer boundaries, wherein the set of receiving antennas are oriented to capture both parallel and perpendicular polarizations relative to the transmitted waves;
implementing, through a processing unit, at least a four-dimensional suppression of unwanted signals from the detected reflected electromagnetic waves;
determining electromagnetic properties of the detected subsurface material layers through spiral estimation;
calculating, for each detected material layer at least, a dielectric permittivity, a conductivity, a wavelength, and a skin depth based on the reflected electromagnetic waves;
collecting a environmental calibration data through a set of temperature sensors and a set of position tracking devices;
storing the processed reflection data and calculated electromagnetic parameters in a data storage unit;
coordinating timing between the signal transmission and reception;
managing the environmental sensor data collection;
executing real-time signal processing algorithms;
implementing Fresnel equation calculations to determine reflection and transmission coefficients;
performing nearest neighbor searches for parameter estimation;
generating three-dimensional subsurface maps based on the calculated electromagnetic parameters;
determining a set of electromagnetic properties of each material layer from the processed reflected waves;
generating a comprehensive characterization of subsurface media including layer thickness and electromagnetic parameters; and
enabling lexicographic imaging based on full polarization analysis of the reflected waves.

8. The method of claim 7, wherein determining electromagnetic properties through spiral estimation that further comprises calculating a ratio of reflection coefficients across boundaries between media; applying a Nearest Neighbor Search method to determine a relative dielectric permittivity of each medium; identifying a minimum difference between the ratio of reflection coefficients and a ratio of measured complex signal powers; and iteratively determining the electromagnetic properties of subsequent layers based on the calculated ratios and coefficients.

9. The method of claim 7, wherein calculating the electromagnetic parameters further comprises determining a wavelength of the electromagnetic wave traveling through each medium according to λ=c/(f√ϵr); calculating a two-way travel time between transmitted and received responses; estimating a depth of each medium based on the measured travel time and determined wavelength; and computing a total accumulated phase shift based on the depth of the medium and the wavelength of the electromagnetic wave.

10: The method of claim 7, wherein digitally implementing the Fresnel equation calculations further comprises determining reflection coefficients rp and rs for parallel and perpendicular polarizations; calculating transmission coefficients tp and ts for parallel and perpendicular polarizations; applying Snell's Law to determine angles of reflection and transmission at layer boundaries; and computing the ratio of reflection coefficients across each boundary to characterize subsequent layer properties.

11. The method of claim 7, wherein executing real-time signal processing algorithms further comprises performing initial range filtering to remove unwanted reflections; implementing polarimetric analysis of the received signals; executing phase coherence maintenance between orthogonal polarization channels; and applying temperature compensation based on the collected environmental calibration data.

12. The method of claim 7, wherein generating the comprehensive characterization further comprises: calculating a skin depth for each medium using a determined attenuation constant α and propagation constant J; establishing a relationship between conductivity and permittivity through a ratio of phase shift to logarithmic path loss; determining a two-way path loss based on measured complex signal power magnitude; and generating at least a layer-specific electromagnetic parameter profiles from a group comprising dielectric permittivity, conductivity, wavelength, and skin depth.

13. An apparatus for characterizing subsurface electromagnetic properties of multiple material layers, the apparatus comprising:
at least a transmitter housing containing a signal generation assembly, the signal generation assembly further comprising a frequency generator configured to produce electromagnetic waves at a predetermined center frequency with a specified bandwidth, and a dual-polarized transmitter array configured to transmit orthogonally polarized electromagnetic waves;
at least a receiver housing containing a reception assembly, the reception assembly further comprising a set of dual-polarized receiving antennas structurally arranged to detect reflected electromagnetic waves from subsurface layer boundaries, wherein the set of receiving antennas are physically oriented to capture both parallel and perpendicular polarizations relative to the transmitted waves;
at least a processing assembly operatively connected to the reception assembly, wherein the processing assembly comprises: a signal processing circuit further comprising a range filtering component structured to implement at least a four-dimensional suppression of unwanted signals; a parameter estimation circuit comprising computational components configured to implement spiral estimation for determining electromagnetic properties of detected subsurface material layers; a characterization circuit structured to calculate dielectric permittivity, conductivity, wavelength, and skin depth for each detected material layer based on the reflected electromagnetic waves;
an environmental monitoring assembly comprising a plurality of temperature sensors and position tracking devices physically arranged to provide calibration data;
a memory device structured to store processed reflection data and calculated electromagnetic parameters;
a control assembly operatively connected to the processing assembly, the control assembly comprising: a timing circuit structured to coordinate signal transmission and reception; an environmental data collection circuit; a signal processing circuit configured to execute real-time algorithms; a computation circuit structured to implement Fresnel equation calculations; a parameter estimation circuit configured to perform nearest neighbor searches; a mapping circuit structured to generate three-dimensional subsurface maps;
wherein the apparatus is structurally arranged to: direct electromagnetic waves into a ground target comprising multiple material layers; collect reflected waves from boundaries between the material layers; process the reflected waves to determine electromagnetic properties of each layer; generate subsurface media characterization including layer thickness and electromagnetic parameters; produce lexicographic imaging based on full polarization analysis of the reflected waves.

14. The apparatus of claim 13, wherein the signal generation assembly further comprises a power amplification stage integrated within the transmitter housing; a transmission control circuit configured to maintain phase coherence across transmission channels; a temperature-stabilized oscillator operating at a channel defined frequency and a corresponding bandwidth; and signal conditioning circuits configured to maintain signal integrity between the frequency generator and the dual-polarized transmitter array.

15. The apparatus of claim 13, wherein the reception assembly further comprises at least a low-noise amplifier physically integrated within the receiver housing; an at least anti-aliasing filters configured to operate across a specified bandwidth; at least a high-speed analog-to-digital converters structurally arranged to digitize the received signals; and signal conditioning circuits configured to maintain signal fidelity between the receiving antennas and the processing assembly.

16. The apparatus of claim 13, wherein the parameter estimation circuit is structurally configured to calculate reflection coefficients according to the ratio rp1/rs1 for a first boundary; determine a relative dielectric permittivity through at least a nearest neighbor search methods;
compute at least a transmission coefficient using Snell's Law and Fresnel's Equations; and characterize at least a subsequent layer properties through iterative coefficient calculations.

17. The apparatus of claim 13, wherein the environmental monitoring assembly further comprises at least a temperature control circuits maintaining 22° C. operating temperature; a GPS module physically integrated with an inertial measurement unit; and at least a barometric pressure sensor for altitude reference.

18. The apparatus of claim 13, wherein the characterization circuit is structured to: calculate a wavelength of electromagnetic waves in each medium using λ=c/(f√ϵr); determine a two-way path loss according to k2=Pp2/(tp1rp2tp3); compute a total accumulated phase shift using ϕ2=(4πd√ϵr2)/c; and characterize a skin depth of each medium through calculation of attenuation constant α and propagation constant β.
